(19) United States
(12) Patent Application Publication
(10) Pub. No.: US 2011/0187321 A1
(43) Pub. Date: Aug. 4, 2011

(54) WIRELESS CHARGING SYSTEM FOR VEHICLE

(75) Inventor: Makoto Hirayama, Shizouka (JP)

(73) Assignee: YAZAKI CORPORATION, Tokyo (JP)

(21) Appl. No.: 13/063,621

(22) PCT Filed: Sep. 11, 2009
(86) PCT No.: PCT/JP2009/065952

§ 371 Date: Apr. 25, 2011

(30) Foreign Application Priority Data
Sep. 11, 2008 (JP) 2008-232874

(51) Int. Cl. H01F 38/14

(52) U.S. Cl. 320/108

(57) ABSTRACT

A control signal is superimposed on an AC power at the time of charging the battery of an electric car in a non-contact manner by electric power outputted from a feeding apparatus. A feeding apparatus 11 includes a carrier oscillator 21 for outputting an AC power, an ASK modulator 22 for superimposing a control signal on the AC power outputted from the carrier oscillator 21 according to the ASK modulation method, a power amplifier 23 for amplifying the AC power modulated by the ASK modulator 22, and a first resonance coil 24 for outputting the AC power amplified by the power amplifier 23. A charging apparatus 12 to be provided on an electric car includes a second resonance coil 31 for receiving the AC power transmitted from the first resonance coil 24, an ASK demodulator 34 for demodulating the received AC power to thereby extract the control signal, and a rectifier 33 which rectifiers the received AC power to obtain a DC power and supplies the DC power to a battery 35.

### TECHNICAL FIELD

The present invention relates to a wireless charging system for a vehicle which transmits, in a non-contact manner, electric power outputted from a feeding apparatus to a battery mounted on a vehicle and, in particular, relates to a technique of communicating between the feeding apparatus and the vehicle in a manner of superimposing a control signal on an electric power signal transmitted to the vehicle from the feeding apparatus.

### BACKGROUND TECHNIQUE

As a charging system for charging electric power to the battery of an electric car, there is known one which is disclosed in JP-A-2006-74868 (patent document 1), for example. Since the charging system described in the patent document 1 is configured in a manner that a non-contact type charging system based on electromagnetic induction is employed to supply electric power for charging the battery to the vehicle in a non-contact manner to thereby charge the battery. Thus, the battery can be charged easily without requiring such an operation of plug connection.

Further, according to such the charging system, it is necessary to transmit and receive, between a feeding side apparatus and the vehicle, various kinds of control signals representing information of the remaining capacity of the battery, possible/impossible as to the charging, emergency stop due to the occurrence of abnormality, for example. Such the communication is performed by using a communication apparatus provided separately.

### PRIOR PATENT DOCUMENT

[Patent Document 1] JP-A-2006-74868

### DISCLOSURE OF THE INVENTION

### Problems that the Invention is to Solve

As described above, according to the wireless charging system for a vehicle of the related art, it is necessary to provide a communication section at each of the feeding side apparatus and the vehicle in order to transmit and receive the control signal between the feeding side apparatus and the vehicle. Thus, there arises a problem that the configuration of the system is complicated and grown in size.

The invention is made in order to solve the aforesaid problem of the related art and an object of the invention is to provide a wireless charging system for a vehicle which transmits and receives a control signal by superimposing the control signal on an electric power signal transmitted to a vehicle from a feeding apparatus to thereby simplify the configuration of the system.

### Means for Solving the Problems

In order to attain the aforesaid object, the first mode of the invention is that, in a wireless charging system for a vehicle which transmits electric power outputted from a feeding apparatus to a vehicle side in a non-contact manner to thereby charge a battery mounted on the vehicle, wherein the feeding apparatus includes:

an electric power output section which outputs AC power;

a modulation section which superimposes a control signal on the AC power outputted from the electric power output section by using a predetermined modulation method;

an electric power amplifying section which amplifies the AC power modulated by the modulation section; and

a first communication terminal which transmits the AC power amplified by the electric power amplifying section, and

wherein the vehicle includes:

a second communication terminal which receives the AC power transmitted from the first communication terminal;

a demodulation section which demodulates the AC power received by the second communication terminal to thereby extract the control signal; and

a rectifying section which rectifies the AC power and supplies a DC power obtained by rectifying the AC power to the battery.

The second mode of the invention is that the vehicle includes distributing section which distributes the AC power received by the second communication terminal into an AC power of a large power and an AC power of a small power,

the demodulation section extracts the control signal from the AC power of the small power, and

the rectifying section rectifies the AC power of the large power.

The third mode of the invention is that the DC power obtained by rectifying the AC power of the large power is used as electric power for driving the demodulation section.

The fourth mode of the invention is that the first communication terminal has a transmission/reception function for transmitting the AC power and receiving the signal transmitted from the second communication terminal,

the second communication terminal has transmission/reception function for receiving the AC power and transmitting the signal to the first communication terminal,

the feeding apparatus includes a transmission/reception switch section for switching the first communication terminal in a transmission mode or a reception mode,

the vehicle includes a reception/transmission switch section for switching the second communication terminal in a reception mode or a transmission mode,

in a case of transmitting the AC power to the second communication terminal from the first communication terminal, the transmission/reception switch section is set to the transmission mode and the reception/transmission switch section is set to the reception mode,

in a case of transmitting the signal to the first communication terminal from the second communication terminal, the transmission/reception switch section is set to the reception mode and the reception/transmission switch section is set to the transmission mode, and the second communication terminal transmits the control signal by using an attenuated signal of the AC power as a carrier.

The fifth mode of the invention is that the vehicle includes a vehicle side transmission section which transmits the control signal to the feeding apparatus,

the feeding apparatus includes a feeding side reception section which receives the control signal transmitted from the vehicle side,

the vehicle side transmission section includes an oscillation section which oscillates a carrier signal having a frequency different from a frequency of the AC signal, and the vehicle side transmission section superimposes the control signal on the carrier signal outputted from the oscillation section by using the predetermined modulation method and transmits the carrier signal to the feeding side reception section.

The sixth mode of the invention is that the vehicle side transmission section includes a carrier signal generation section which separates and extracts the carrier signal from the AC power received by the second communication terminal and changes a frequency of the carrier signal into another frequency, and the vehicle side transmission section superimposes the control signal on the carrier signal generated by the carrier signal generation section by using the predetermined modulation method and transmits the carrier signal to the feeding side reception section.

The sixth mode of the invention is that the vehicle side transmission section separates and extracts the carrier signal from the AC power received by the second communication terminal and superimposes the control signal on the extracted carrier signal by using a frequency modulation method and transmits the carrier signal to the feeding side reception section.

### Effects of the Invention

According to the wireless charging system for a vehicle according to the invention, the AC power outputted from the electric power output section is amplified and further the AC power thus amplified is transmitted to the vehicle side by using the resonant power transmission method to thereby charge the battery. Thus, since the battery can be charged without coupling the feeding apparatus and the vehicle via a plug etc., the charging operation can be performed easily.

Further, since the control signal to be transmitted from the feeding apparatus to the vehicle can be superimposed on the AC power and transmitted, the control signal can be transmitted between the feeding apparatus and the vehicle. Thus, since the communication can be performed between the feeding apparatus and the vehicle without separately providing a communication apparatus, the system can be miniaturized and simplified, which contributes to the light-weighting of the weight of the vehicle body.

### BRIEF DESCRIPTION OF THE DRAWINGS

FIG. 1 is an explanatory diagram showing the electric car and the feeding apparatus of a wireless charging system for a vehicle according to the first and second embodiments of the invention.

FIG. 2 is a block diagram showing the electrical configuration of the feeding apparatus and the charging apparatus of the wireless charging system for a vehicle according to the first embodiment of the invention.

FIG. 3 is a block diagram showing the electrical configuration of the feeding apparatus and the charging apparatus of the wireless charging system for a vehicle according to the second embodiment of the invention.

FIG. 4 is timing charts showing signal waveforms at the respective points of the wireless charging system for a vehicle shown in FIG. 3.

FIG. 5 is an explanatory diagram showing the electric car and the feeding apparatus of a wireless charging system for a vehicle according to the third to fifth embodiments of the invention.

FIG. 6 is a block diagram showing the electrical configuration of the feeding apparatus and the charging apparatus of the wireless charging system for a vehicle according to the third embodiment of the invention.

FIG. 7 is a block diagram showing the electrical configuration of the feeding apparatus and the charging apparatus of the wireless charging system for a vehicle according to the fourth embodiment of the invention.

FIG. 8 is a block diagram showing the electrical configuration of the feeding apparatus and the charging apparatus of the wireless charging system for a vehicle according to the fifth embodiment of the invention.

FIG. 9 is an explanatory diagram showing the principle of the resonant power transmission method.

### MODES FOR CARRYING OUT THE INVENTION

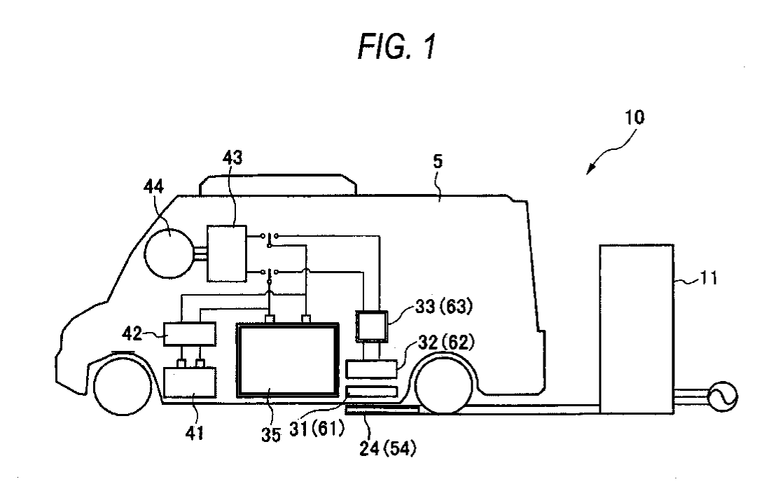

Hereinafter, embodiments according to the invention will be explained with reference to drawings. FIG. 1 is a diagram for explaining the configuration of a wireless charging system for a vehicle according to the first and second embodiments of the invention. As shown in this figure, the wireless charging system 10 for a vehicle according to each of these embodiments includes an electric car 5 (vehicle) and a feeding apparatus 11 for feeding electric power to the electric car 5, whereby electric power outputted from the feeding apparatus 11 is transmitted to the electric car 5 in a non-contact manner.

The feeding apparatus 11 includes a first resonance coil 24. When AC power is supplied to the first resonance coil 24, the AC power is transmitted to a second resonance coil (second communication terminal) 31 provided at the electric car 5.

The electric car 5 includes a second resonance coil 31 which approximates to the first resonance coil 24 when a vehicle is located at the predetermined position of the feeding apparatus 11 at the time of charging, a coupling distributor (distributing section) 32 and a rectifier (rectifying section) 33. Further, the electric car includes a battery 35 for charging DC power, a DC/DC converter 42 which steps down the voltage of the battery 35 and supplies to a sub-battery 41, an inverter 43 for converting the output power of the battery 35 into AC power, and a vehicle driving motor 44 driven by the AC power outputted from the inverter 43.

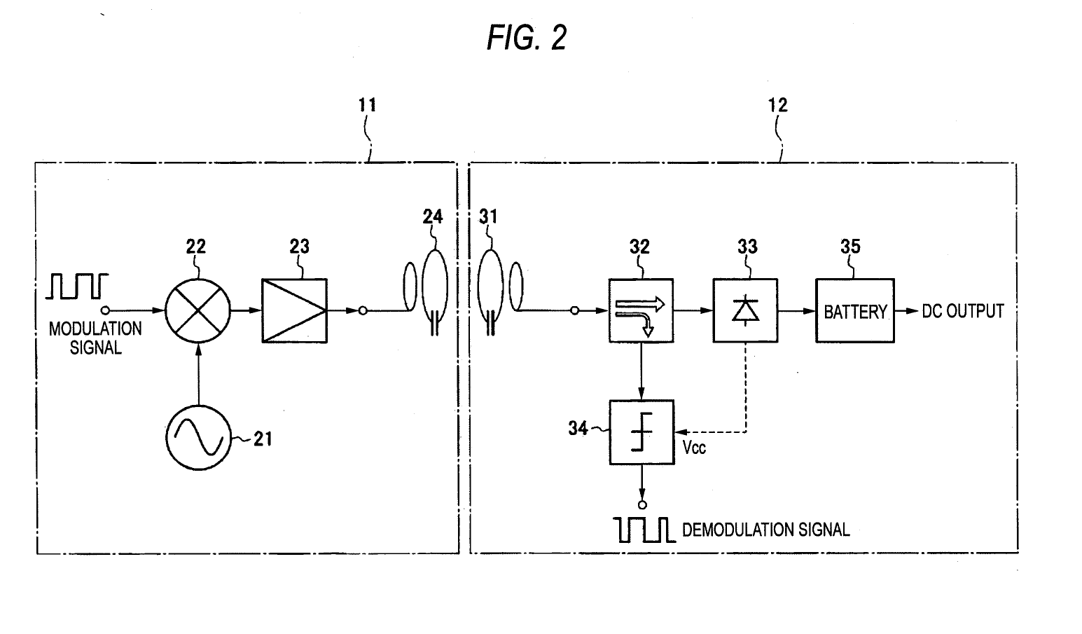

FIG. 2 is a block diagram showing the configuration of the wireless charging system for a vehicle according to the first embodiment of the invention. As shown in this figure, the electric car 5 includes a charging apparatus 12. The charging apparatus 12 is supplied with electric power from the feeding apparatus 11 to thereby charge the battery 35.

The feeding apparatus 11 includes a carrier oscillator (electric power output section) 21 for outputting an AC power of a predetermined frequency, an ASK modulator (modulation section) 22 for superimposing a control signal on the AC power outputted from the carrier oscillator 21 according to a modulation method such as the ASK modulation, a power amplifier (electric power amplifying section) 23 for amplifying the AC power modulated by the ASK modulator, and a first resonance coil (communication terminal) 24 for outputting the AC power amplified by the power amplifier 23.

The carrier oscillator 21 outputs the AC power having the frequency in a range of 1 to 100 [MHz], for example, as an AC signal for power transmission.

The ASK modulator 22 modulates the AC power as a carrier signal according to the ASK (Amplitude Shift Keying) method. As is well known, the ASK is a modulation method which modulates the carrier signal (AC power) in a manner of representing digital data as variations in the amplitude of a sinusoidal wave. Although this embodiment is explained as to a case where the ASK method is employed as the modulation method, one of the modulation methods such as AM (Amplitude Modulation), FM (Frequency Modulation), FSK (Frequency Shift Keying), PSK (Phase Shift Keying), OFDM (Orthogonal frequency division multiplex) and SS (Spread Spectrum) may be applied.

The power amplifier 23 amplifies the AC power outputted from the ASK modulator 22 and outputs the amplified AC power to the first resonance coil 24. The first resonance coil 24 transmits the AC power to the second resonance coil 31 in a non-contact manner by the resonant power transmission method in cooperation with the second resonance coil 31 provided at the charging apparatus 12. The resonant power transmission method will be explained in detail later.

Further, the charging apparatus 12 includes the second resonance coil 31 for receiving the AC power transmitted from the first resonance coil 24, the coupling distributor 32 for distributing the AC power received by the second resonance coil into an AC power of a large power and an AC power of a small power, the rectifier 33 which rectifiers the AC power of the large power outputted from the coupling distributor 32 and generates a DC voltage, and an ASK demodulator (demodulating section) 34 which is driven by the power outputted from the rectifier 33 and demodulates the AC power of the small power outputted from the coupling distributor 32 to thereby extract a control signal. Further, the charging apparatus 12 includes the battery 35 for supplying electric power to the vehicle driving motor 44 for driving the vehicle (see FIG. 1). The battery 35 is charged by the DC power outputted from the rectifier 33.

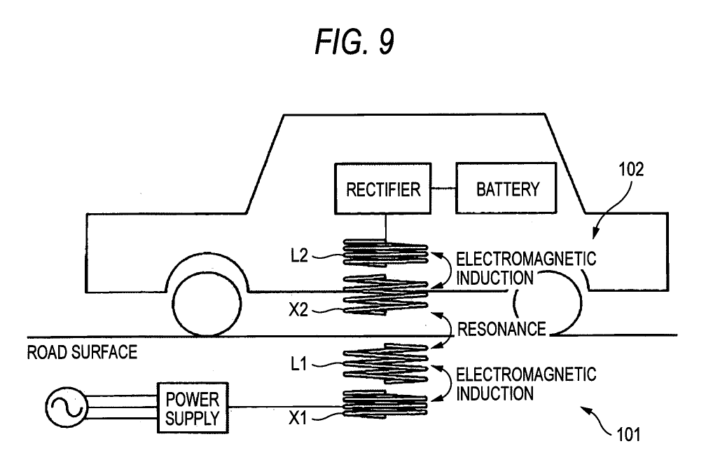

Next, the explanation will be made as to the resonant power transmission method. FIG. 9 is a diagram for explaining the principle of the resonant power transmission method. As shown in this figure, a feeding side circuit 101 is provided with a primary coil L1 and a primary antenna X1 disposed in the vicinity of the primary coil L1. A vehicle side circuit 102 is provided with a secondary coil L2 and a secondary antenna X2 disposed in the vicinity of the secondary coil L2.

When a primary current is flows through the primary coil L1, an induction current flows through the primary antenna X1 due to the electromagnetic induction. Further, the primary antenna X1 resonates at a resonance frequency ωs (=1/√Ls·Cs) according to the inductance Ls and the stray capacitance Cs of the primary antenna X1. Then, the secondary antenna X2 provided in the vicinity of the primary antenna X1 at the resonance frequency ωs, whereby a secondary current flows through the secondary antenna X2. Further, the secondary current flows through the secondary coil L2 disposed in the vicinity of the secondary antenna X2 due to the electromagnetic induction.

According to the aforesaid operation, electric power can be supplied in the non-contact manner to the vehicle side circuit 102 from the feeding side circuit 101.

Next, the explanation will be made as to the operation of the wireless charging system for a vehicle according to the first embodiment of the invention shown in FIGS. 1 and 2. As shown in FIG. 1, when the electric car 5 is located at the predetermined position of the feeding apparatus 11 where the first resonance coil 24 provided at the feeding apparatus 11 opposes to the second resonance coil 31 provided at the charging apparatus 12 of the electric car 5, the battery 35 can be charged.

When the charging is started, the AC power having the frequency almost in the range of 1 to 100 [MHz] is outputted from the carrier oscillator 21 shown in FIG. 2. The AC power is supplied to the ASK modulator 22, whereby the control signal to be transmitted to the charging apparatus 12 from the feeding apparatus 11 is superimposed on the AC power according to the ASK modulation method. That is, the AC power is used as the carrier signal.

The AC power outputted from the ASK modulator 22 is amplified by the power amplifier 23. The amplified AC power is transmitted to the charging apparatus 12 via the first resonance coil 24 and the second resonance coil 31 according to the aforesaid principle of the resonant power transmission.

The AC power transmitted to the charging apparatus 12 is supplied to the coupling distributor 32. The coupling distributor 32 distributes the inputted AC power into the AC power of the large power and the AC power of the small power, and outputs the AC power of the large power to the rectifier 33. On the other hand, the coupling distributor outputs the AC power of the small power to the ASK demodulator 34.

The rectifier 33 rectifies the AC power of the large power to convert into the DC power of a predetermined voltage and supplies this DC power to the battery 35 to thereby charge the battery 35. Thus, the battery 35 can be charged. Further, the DC power outputted from the rectifier 33 is supplied to the ASK demodulator 34 as electric power for driving the ASK demodulator 34.

The ASK demodulator 34 demodulates the AC power of the small power according to the ASK demodulation to extract the control signal superimposed on the AC power of the small power. Thus, the charging apparatus 12 can receive the control signal transmitted from the feeding apparatus 11.

In this manner, according to the wireless charging system for a vehicle according to the first embodiment of the invention, the AC power outputted from the carrier oscillator 21 is amplified and further the AC power thus amplified is transmitted to the charging apparatus 12 by using the resonant power transmission method to thereby charge the battery 35. Thus, since the battery of the electric car 5 can be charged without coupling the feeding apparatus 11 and the charging apparatus 12 via a plug etc., the charging operation can be performed easily.

Further, the control signal is superimposed on the AC power by using the modulation method such as the ASK modulation in the feeding apparatus 11, and the AC power transmitted from the charging apparatus is demodulated in the charging apparatus 12 to extract the control signal superimposed on the AC power. Thus, the control signal can be transmitted to the electric car 5 from the feeding apparatus 11 without separately providing a communication apparatus between the feeding apparatus 11 and the charging apparatus 12. As a result, the system can be miniaturized and simplified.

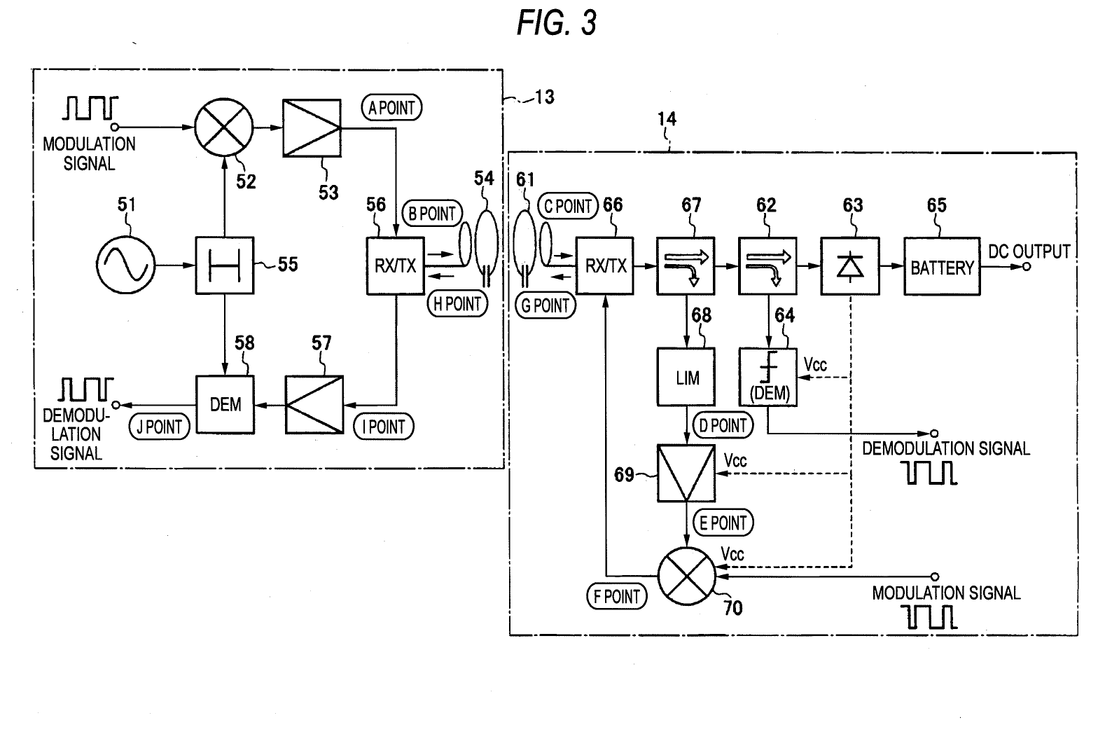

Next, the explanation will be made as to the second embodiment of the invention. FIG. 3 is a block diagram showing the configuration of the wireless charging system for a vehicle according to the second embodiment. The wireless charging system for a vehicle according to the second embodiment differs from the aforesaid first embodiment in a point that both the data transmission to a charging apparatus 14 from a feeding apparatus 13 and the data transmission to the feeding apparatus 13 from the charging apparatus 14 is performed each by using the AC power as a carrier.

As shown in FIG. 3, the wireless charging system for a vehicle according to the second embodiment includes the feeding apparatus 13 and the charging apparatus 14.

The feeding apparatus 13 includes a carrier oscillator 51 for outputting an AC power, a hybrid distributor 55 for distributing the AC power outputted from the carrier oscillator 51 into two AC powers, an ASK modulator 52 for superimposing a control signal on one of the two AC powers distributed by the hybrid distributor 55 according to a modulation method such as the ASK modulation, a power amplifier 53 for amplifying the AC power modulated by the ASK modulator 52, and a first resonance coil 54 for outputting the AC power amplified by the power amplifier 53.

Further, the feeding apparatus is provided, between the power amplifier 53 and the first resonance coil 54, with a transmission/reception selection switch 56 for switching between the transmission and the reception. Furthermore, the feeding apparatus is provided with a power amplifier 57 for amplifying a carrier signal received via the transmission/reception selection switch 56 and an ASK demodulator (DEM) 58 for demodulating the carrier signal amplified by the power amplifier 57 and extracting the control signal. The ASK demodulator (DEM) 58 is supplied with an AC power outputted from the hybrid distributor 55.

The carrier oscillator 51 outputs the AC power having the frequency in the range of 1 to 100 [MHz], for example, as an AC signal for power transmission.

The ASK modulator 52 modulates the AC power as the carrier signal according to the ASK (Amplitude Shift Keying) method. In place of the ASK, one of the modulation methods such as AM (Amplitude Modulation), FM (Frequency Modulation), FSK (Frequency Shift Keying), PSK (Phase Shift Keying), OFDM (Orthogonal frequency division multiplex) and SS (Spread Spectrum) may be applied.

The power amplifier 53 amplifies the AC power outputted from the ASK modulator 52 and outputs the amplified AC power to the first resonance coil 54. The first resonance coil 54 transmits the AC power to a second resonance coil 61 in a non-contact manner by the aforesaid resonant power transmission method in cooperation with the second resonance coil 61 provided at the charging apparatus 14.

The transmission/reception selection switch 56 controls so as to switch between a transmission mode for transmitting the electric power and the control signal to the charging apparatus 14 and a reception mode for receiving the control signal transmitted from the charging apparatus 14. That is, the AC power is transmitted from the first resonance coil 54 when the transmission mode is selected, whilst the AC power transmitted from the second resonance coil 61 is received via the first resonance coil 54 when the reception mode is selected.

The power amplifier 57 amplifies the received carrier signal and outputs to the ASK demodulator (DEM) 58. The ASK demodulator (DEM) 58 demodulates the received signal and extracts the control signal.

On the other hand, the charging apparatus 14 includes the second resonance coil 61for receiving the AC power transmitted from the first resonance coil 54, two coupling distributors 67, 62 each for distributing the AC power received by the second resonance coil into an AC power of a large power and an AC power of a small power, a limiter (LIM) 68 for limiting the amplitude of the AC power of the small power outputted from the coupling distributor 67 to obtain the AC power of an almost constant amplitude, and a power amplifier 69 for amplifying the AC power outputted from the limiter (LIM) 68.

Further, the charging apparatus includes an ASK demodulator (DEM) 64 for demodulating the AC power of the small power outputted from the coupling distributor 62 and extracting the control signal, and a rectifier 63 for rectifying the AC power of the large power outputted from the coupling distributor 62 to generate a DC voltage. Each of the ASK demodulator (DEM) 64 and the power amplifier 69 is supplied with and driven by the electric power outputted from the rectifier 63. Furthermore, the charging apparatus includes a battery 65 for supplying electric power to a vehicle driving motor 44 for driving the vehicle (see FIG. 1). The battery 65 is charged by the DC power outputted from the rectifier 63.

Furthermore, the charging apparatus includes an ASK modulator 70. The ASK modulator 70 employs the AC power outputted from the power amplifier 69 as a carrier signal and modulates the control signal according to the ASK modulation method to thereby superimpose the control signal on the carrier signal. The output terminal of the ASK modulator 70 is coupled to a reception/transmission selection switch 66. The ASK modulator 70 is supplied with and driven by the electric power outputted from the rectifier 63.

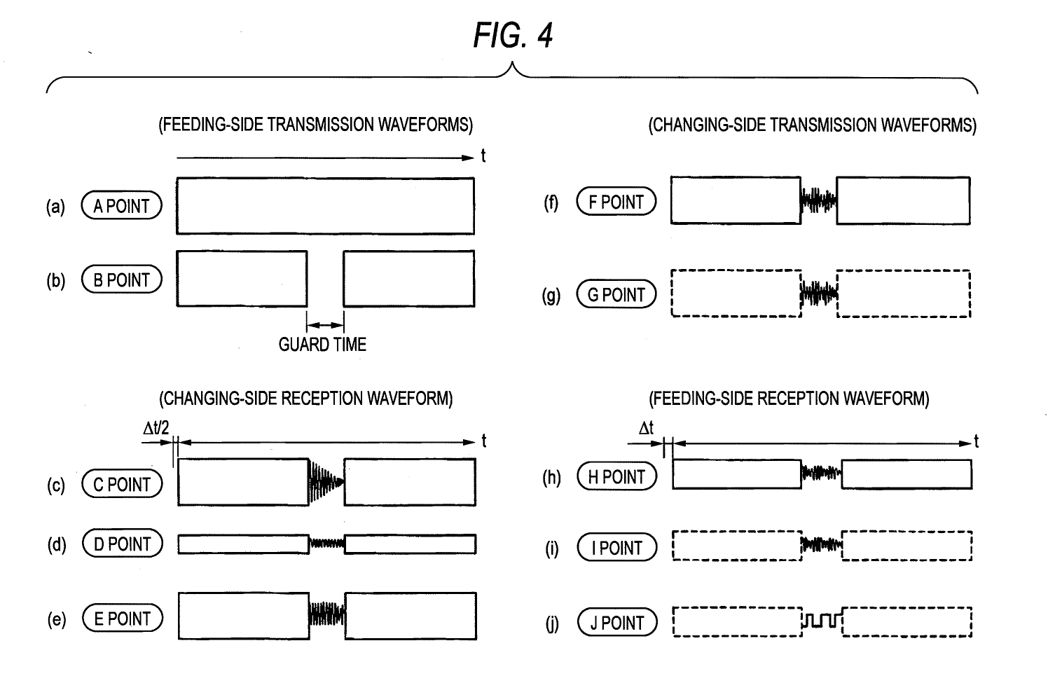

Next, the explanation will be made as to the operation of the wireless charging system for a vehicle shown in FIG. 3 with reference to waveform diagrams shown in FIG. 4. In order to simplify the explanation, each of quadrangles each formed by a surrounded steady line represents that a waveform of the same frequency and the same amplitude continues and each of quadrangles each formed by a surrounded dotted line represents that no waveform is generated.

FIG. 4(a) shows the waveform of the AC power at a point A in FIG. 3 which has constant amplitude. In this case, like the aforesaid first embodiment, this waveform is modulated at the time of transmitting the control signal to the charging apparatus 14 from the feeding apparatus 13.

FIG. 4(b) shows the waveform of the AC power at a point B as the output terminal of the transmission/reception selection switch 56, wherein the signal at the point A is outputted as it is when the transmission/reception selection switch 56 is switched to the transmission mode. In contrast, when the switch is switched to the reception mode, the AC power is not outputted during this time period (this time period s called a guard time).

FIG. 4(c) shows the waveform of the AC power at a point C as the input side of the reception/transmission selection switch 66 of the charging apparatus 14. As shown in this figure, the waveform of the AC power which amplitude attenuates gradually is obtained during the guard time. FIG. 4(d) shows the waveform of the AC power at a point D as the output terminal of the limiter (LM) 68. As shown in this figure, the waveform of the AC power having low constant amplitude is obtained during the guard time.

FIG. 4(e) shows the waveform of the AC power at a point E as the output terminal of the power amplifier 69. This waveform is obtained by amplifying the AC power outputted from the limiter (LM) 68. This AC power is used as the carrier signal at the time of transmitting the control signal to the feeding apparatus 13 from the charging apparatus 14.

FIG. 4(f) shows the waveform of the AC power at a point F as the output terminal of the ASK modulator 70. This waveform represents a signal obtained by subjecting the carrier signal to the ASK modulation. FIG. 4(g) shows the waveform of the AC power at a point G as the output terminal of the reception/transmission selection switch 66, wherein all the signals except for the signal during the guard time are removed.

FIG. 4(h) shows the waveform of the AC power at a point H as the input terminal of the transmission/reception selection switch 56, wherein the modulation signal is generated during the guard time (actually, there is a time delay Δt corresponding to the reciprocal communication).

FIG. 4(i) shows the waveform of the AC power at a point I as the output terminal of the transmission/reception selection switch 56, wherein all the AC power except for the signal during the guard time is removed. FIG. 4(j) shows the waveform of the AC power at a point J as the output terminal of the ASK demodulator (DEM) 58. As shown in this figure, the control signal transmitted from the charging apparatus 14 side is obtained.

In this manner, according to the wireless charging system for a vehicle according to the second embodiment of the invention, the feeding apparatus 13 is provided with the transmission/reception selection switch 56 and the charging apparatus 14 is provided with the reception/transmission selection switch 66. Further, the guard time is provided at a part of the time period for transmitting the AC power to the charging apparatus 14 from the feeding apparatus 13, whereby the control signal is transmitted to the feeding apparatus 13 from the charging apparatus 14 during the guard time.

Thus, not only the AC power is transmitted by using the first resonance coil 54 and the second resonance coil 61 but also the transmission of the control signal to the charging apparatus 14 from the feeding apparatus 13 and the transmission of the control signal to the feeding apparatus 13 from the charging apparatus 14 can be realized by using these coils 54, 61. As a result, it becomes possible to communicate bidirectionally between the feeding apparatus 13 and the electric car 5 without separately providing any communication apparatus between the feeding apparatus 13 and the charging apparatus 14. Accordingly, the system can be downsized and simplified. Further, in the charging apparatus 14, since the control signal is superimposed by using the AC power which is attenuated during the guard time, it is not necessary to separately provide an oscillator for outputting the carrier signal.

Next, the explanation will be made as to a third embodiment of the invention. The wireless charging system for a vehicle according to the third embodiment is same as the first embodiment in a point that the control signal is transmitted to the charging apparatus from the feeding apparatus by using the two resonant coils for the electric power transmission. Additionally, the third embodiment transmits the control signal to the charging apparatus from the feeding apparatus by using a dedicated communication line.

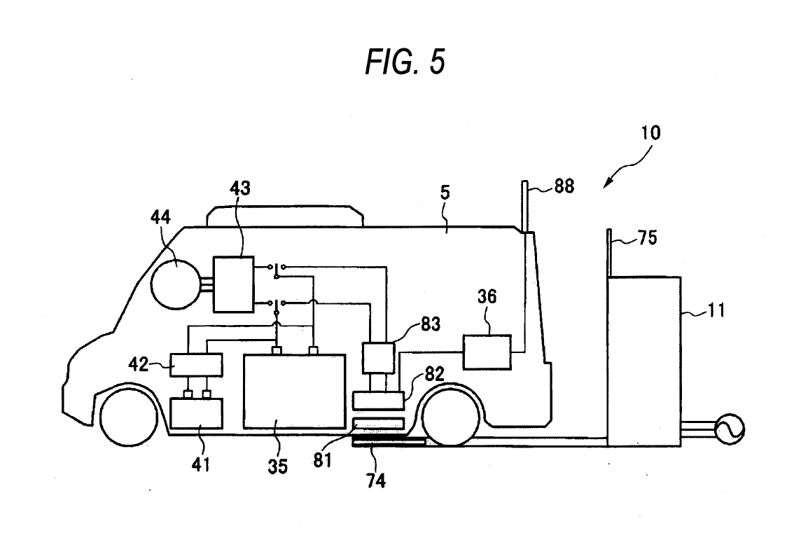

FIG. 5 is a diagram for explaining the configuration of the wireless charging system for a vehicle according to the third embodiment. As shown in this figure, the wireless charging system for a vehicle according to the third embodiment differs from FIG. 1 in a point that a transmission portion 36 and antennas 88, 75 are provided in order to transmit the control signal to the feeding apparatus 11 from the electric car 5. The remaining configuration of this embodiment is same as FIG. 1 and hence the explanation thereof will be omitted.

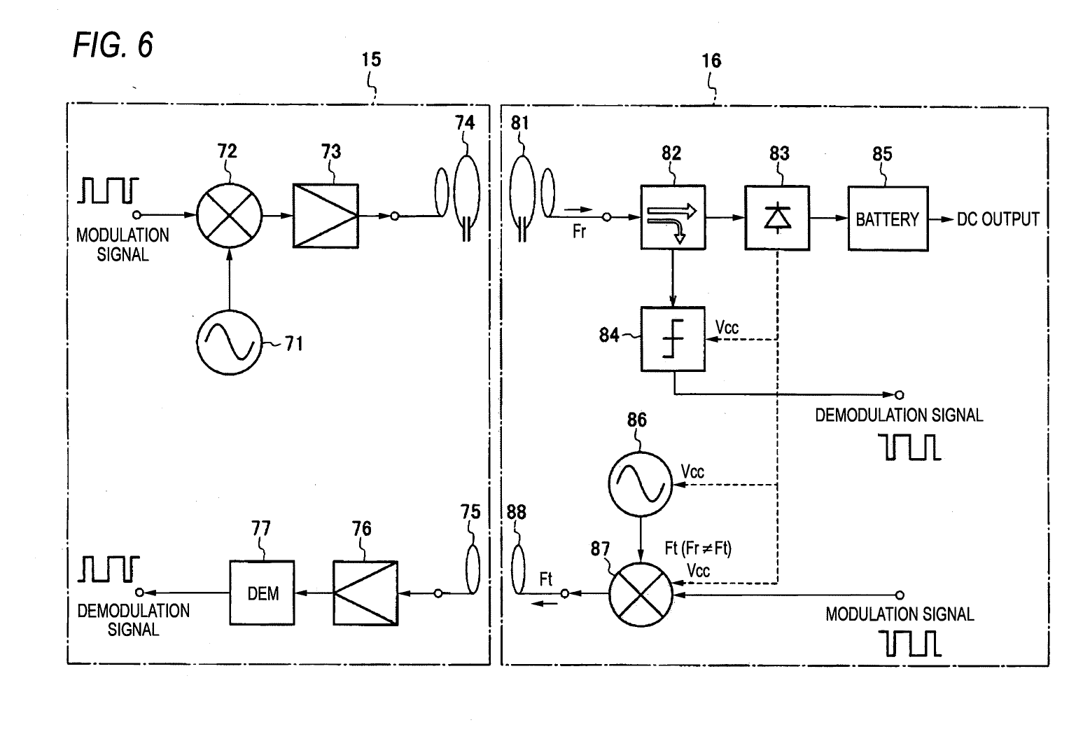

FIG. 6 is a block diagram showing the configuration of the wireless charging system for a vehicle according to the third embodiment. As shown in this figure, a feeding apparatus 15 includes a carrier oscillator 71 for outputting a carrier signal for power transmission, an ASK modulator 72 for superimposing a control signal on the carrier signal outputted from the carrier oscillator 71 according to the modulation method such as the ASK modulation, a power amplifier 73 for amplifying the AC power thus modulated by the ASK modulator 72, and a first resonance coil 74 for outputting the AC power thus amplified by the power amplifier 73.

The carrier oscillator 71 outputs the AC power having the frequency in a range of 1 to 100 [MHz], for example, as an AC signal for power transmission.

The ASK modulator 72 modulates the AC power as the carrier signal according to the ASK (Amplitude Shift Keying) method. Although this embodiment is explained as to an example where the ASK method is employed as the modulation method, in place of the ASK, one of the modulation methods such as AM (Amplitude Modulation), FM (Frequency Modulation), FSK (Frequency Shift Keying), PSK (Phase Shift Keying), OFDM (Orthogonal frequency division multiplex) and SS (Spread Spectrum) may be applied.

The power amplifier 73 amplifies the AC power outputted from the ASK modulator 72 and outputs the amplified AC power to the first resonance coil 74. The first resonance coil 74 transmits the AC power to a second resonance coil 81 in the non-contact manner by the aforesaid resonant power transmission method in cooperation with the second resonance coil 81 provided at the charging apparatus 16.

The charging apparatus 16 includes the second resonance coil 81 for receiving the AC power transmitted from the first resonance coil 74, a coupling distributor 82 for distributing the AC power received by the second resonance coil 81 into an AC power of a large power and an AC power of a small power, a rectifier 83 which rectifiers the AC power of the large power outputted from the coupling distributor 82 and generates a DC voltage, and an ASK demodulator (DEM) 84 which is driven by the power outputted from the rectifier 83 and demodulates the AC power of the small power to thereby extract the control signal. Further, the charging apparatus includes the battery 85 for supplying electric power to the vehicle driving motor 44 for driving the vehicle (see FIG. 5). The battery 85 is charged by the DC power outputted from the rectifier 83.

Further, the charging apparatus 16 includes an oscillator 86 for outputting a carrier signal having a frequency different from the frequency of the AC power outputted from the carrier oscillator 71, an ASK modulator 87 for modulating the carrier signal according to the ASK modulation method to thereby superimpose a control signal, and the antenna 88 for transmitting the carrier signal thus subjected to the ASK modulation. Each of the oscillator 86 and the ASK modulator 87 is supplied with and driven by the electric power outputted from the rectifier 83.

On the other hand, the feeding apparatus 15 includes the antenna 75 for receiving the carrier signal transmitted from the charging apparatus 16, a power amplifier 76 for amplifying the carrier signal received by the antenna 75, and a demodulator (DEM) 77 for demodulating the output signal from the power amplifier 76 and extracting the control signal.

Next, the explanation will be made as to the operation of the wireless charging system for a vehicle according to the third embodiment shown in FIGS. 5 and 6. As shown in FIG. 5, when the electric car 5 is located at the predetermined position of the feeding apparatus 15 where the first resonance coil 74 provided at the feeding apparatus 15 opposes to the second resonance coil 81 provided at the charging apparatus 16 of the electric car 5, the battery 85 can be charged.

When the charging is started, the AC power having the frequency almost in the range of 1 to 100 [MHz] is outputted from the carrier oscillator 71 shown in FIG. 6. The AC power is supplied to the ASK modulator 72, whereby the control signal to be transmitted to the charging apparatus 16 from the feeding apparatus 15 is superimposed on the AC power according to the ASK modulation method.

The AC power outputted from the ASK modulator 72 is amplified by the power amplifier 73. The amplified AC power is transmitted to the charging apparatus 16 via the first resonance coil 74 and the second resonance coil 81 according to the aforesaid principle of the resonant power transmission.

The AC power transmitted to the charging apparatus 16 is supplied to the coupling distributor 82. The coupling distributor 82 distributes the inputted AC power into the AC power of the large power and the AC power of the small power, and outputs the AC power of the large power to the rectifier 83. On the other hand, the coupling distributor outputs the AC power of the small power to the ASK demodulator (DEM) 84.

The rectifier 83 rectifies the AC power of the large power to convert into the DC power of a predetermined voltage and supplies this DC power to the battery 85 to thereby charge the battery 85. Thus, the battery 85 can be charged. Further, the DC power outputted from the rectifier 83 is supplied to the ASK demodulator (DEM) 84 as electric power for driving the ASK demodulator (DEM) 84 and also supplied to the oscillator 86 as electric power for driving the oscillator 86.

The ASK demodulator (DEM) 84 demodulates the AC power of the small power to extract the control signal superimposed on the AC power of the small power. Thus, the charging apparatus 12 can receive the control signal transmitted from the feeding apparatus 11.

Next, the explanation will be made as to the operation for transmitting the control signal to the feeding apparatus 15 from the charging apparatus 16. The ASK modulator 87 superimposes the control signal on the carrier signal outputted from the oscillator 86 according to the ASK modulation method and transmits the carrier signal from the antenna 88. The carrier signal thus transmitted is received by the antenna 75 of the feeding apparatus 15, then amplified by the power amplifier 76 and demodulated by the demodulator (DEM) 77 to thereby extract the control signal. In this case, since the frequency (Ft) of the carrier signal outputted from the oscillator 86 differs from the frequency (Fr) of the AC power outputted from the carrier oscillator 71, the mutual interference there-between can be avoided.

In this manner, according to the wireless charging system for a vehicle according to the third embodiment of the invention, like the aforesaid first embodiment, the AC power outputted from the carrier oscillator 71 is amplified and further the AC power thus amplified is transmitted to the charging apparatus 16 by using the resonant power transmission method to thereby charge the battery 85. Thus, since the battery of the electric car 5 can be charged without coupling the feeding apparatus 15 and the charging apparatus 16 via a plug etc., the charging operation can be performed easily.

Further, the control signal is superimposed on the AC power according to the modulation method such as the ASK in the feeding apparatus 15, and the AC power is demodulated to thereby extract the control signal superimposed on the AC power in the charging apparatus 16. Thus, the communication between the apparatus 215 and the electric car 5 can be realized without separately providing a communication apparatus between the feeding apparatus 15 and the charging apparatus 16.

Further, the control signal can be transmitted to the feeding apparatus 15 from the charging apparatus 16 by using the dedicated communication line. In this case, since the communication line is used for the one-way transmission to the feeding apparatus 15 from the charging apparatus 16, it is not necessary to employ the bidirectional communication and hence the system can be miniaturized and simplified.

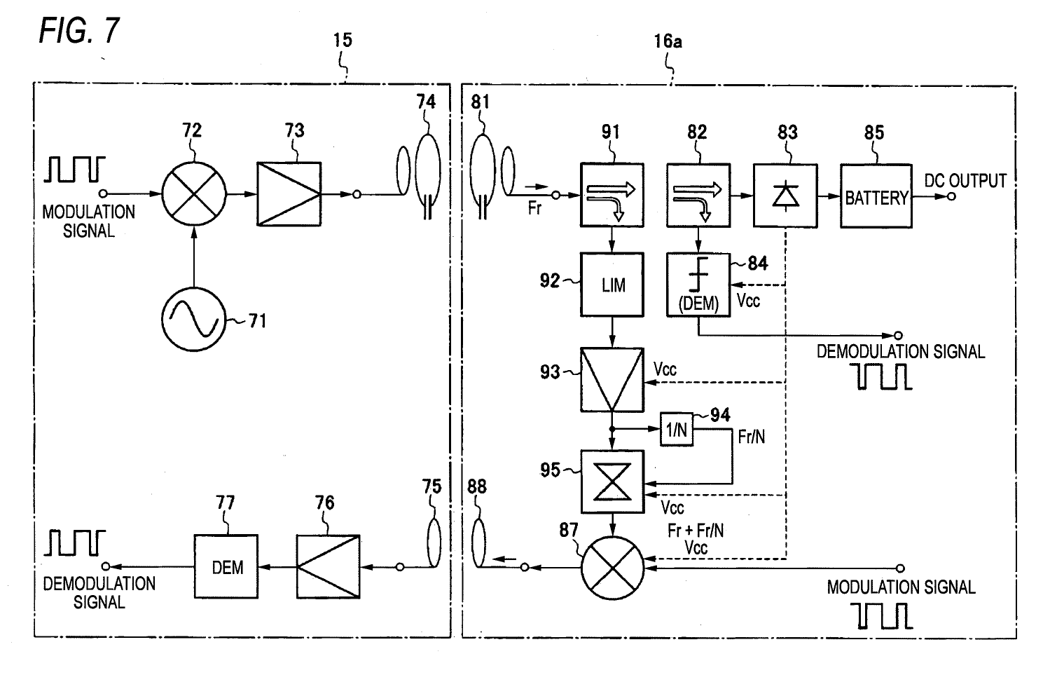

Next, the explanation will be made as to the fourth embodiment of the invention. FIG. 7 is a block diagram showing the configuration of the wireless charging system for a vehicle according to the fourth embodiment. The fourth embodiment differs from the third embodiment in a point that a carrier signal is generated by using the AC power transmitted from the feeding apparatus 15 without using the oscillator (see FIG. 6) and the control signal is transmitted to the feeding apparatus 15 from a charging apparatus 16a by using the carrier signal thus generated.

That is, as shown in FIG. 7, the charging apparatus includes a coupling distributor 91 for extracting an AC power of a small power from the AC power received by the second resonance coil 81, a limiter (LIM) 92 for limiting the amplitude of the AC power outputted from the coupling distributor 91 to obtain the AC power of an almost constant amplitude, a power amplifier 93 for amplifying the AC power outputted from the limiter (LIM) 92, a frequency divider 94 for dividing the frequency (Fr) of the AC power amplified by the power amplifier 93 into a frequency of 1/N (N is a natural number) of Fr to obtain the frequency (Fr/N), and a shift unit 95 for shifting the frequency thus divided to obtain the frequency “Fr+(Fr/N)”. The AC power outputted from the shift unit 95 is applied to the ASK modulator 87 as a carrier signal and the control signal is superimposed on the carrier signal according to the ASK modulation method. Each of the power amplifier 93, the shift unit 95 and the ASK modulator 87 is supplied with and driven by the electric power outputted from the rectifier 83.

According to such the configuration, the carrier signal for transmitting the control signal to the feeding apparatus 15 from the charging apparatus 16a can be generated without providing an oscillator in the charging apparatus 16a. Further, since the carrier signal thus generated is arranged to have the frequency different from that of the AC power and those frequencies are not in the relation of an integer multiples mutually, the mutual interference there-between can be avoided.

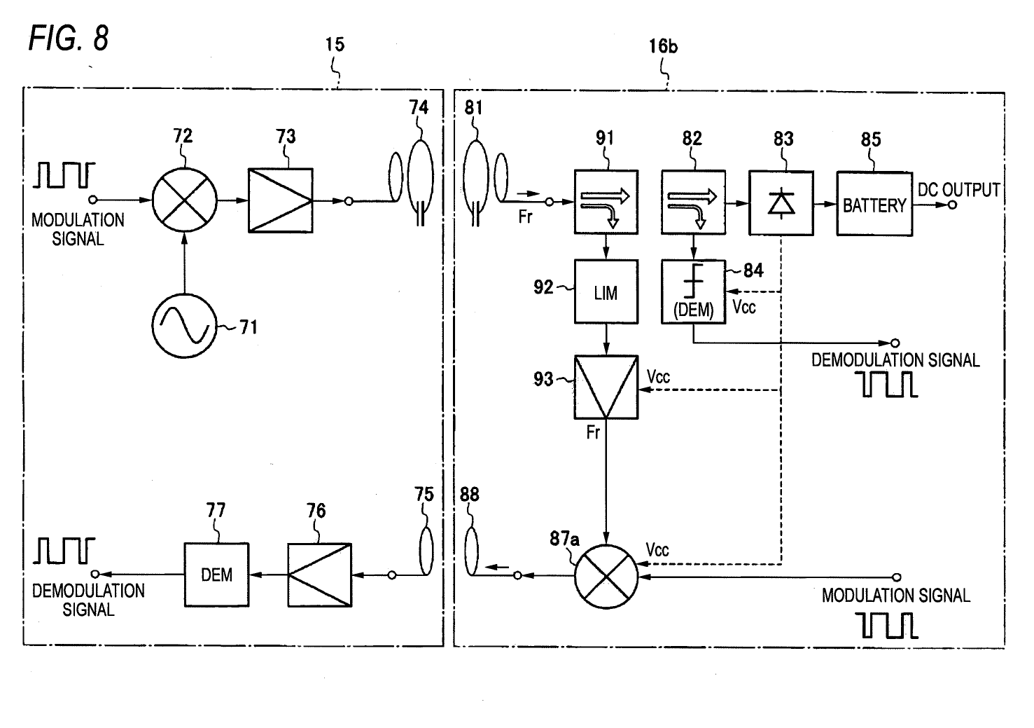

Next, the explanation will be made as to the fifth embodiment of the invention. FIG. 8 is a block diagram showing the configuration of the wireless charging system for a vehicle according to the fifth embodiment. Like the fourth embodiment, the fifth embodiment also includes the coupling distributor 91, the limiter (LIM) 92 and the power amplifier 93. However, the fifth embodiment differs from the fourth embodiment shown in FIG. 7 in a point that this embodiment includes an FSK modulator 87a. In the wireless charging system for a vehicle according to the fifth embodiment, since the control signal is superimposed on the AC power by using the FSK modulator 87a at the time of transmitting the control signal to the feeding apparatus 15 from a charging apparatus 16b, the frequency of the AC power transmitted to the charging apparatus 16b from the feeding apparatus does not coincide with the frequency of the carrier signal transmitted to the feeding apparatus 15 from the charging apparatus 16b, whereby the mutual interference there-between can be avoided. In this case, a modulator of another frequency-modulation method may be employed in place of the FSK modulator 87a. Each of the power amplifier 93 and the FSK modulator 87a is supplied with and driven by the electric power outputted from the rectifier 83.

Further, in the charging apparatus 14 shown in FIG. 3 of the second embodiment, when the ASK modulator 70 is replaced by the FSK modulator or a modulator of another frequency-modulation method, the bidirectional communication can be performed between the feeding apparatus 13 and the charging apparatus 14 without providing any of the transmission/reception selection switch 56 and the reception/transmission selection switch 66 and without providing the guard time for stopping the AC power.

As described above, although the wireless charging system for a vehicle of the invention is explained based on the embodiment shown in the figures, the invention is not limited thereto and the respective configurations of the embodiments may be replaced by arbitrary configurations having the similar functions, respectively.

### INDUSTRIAL APPLICABILITY

This invention is quite usable in the case of charging the battery of an electric car in the non-contact manner by the electric power outputted from the feeding apparatus and communicating the control signal.

### EXPLANATION OF SYMBOLS

5 electric car (vehicle)
11, 13, 15 feeding apparatus
12, 14, 16, 16a, 16b charging apparatus
21 carrier oscillator (electric power output section)
22 ASK modulator (modulation section)
23 power amplifier (electric power amplifying section)
24 first resonance coil (first communication terminal)
31 second resonance coil (second communication terminal)
32 coupling distributor (distributing section)
33 rectifier (rectifying section)
34 ASK demodulator (demodulation section)
35 battery
36 transmission portion
41 sub-battery
42 DC/DC converter
43 inverter
44 motor
51 carrier oscillator
52 ASK modulator
53 power amplifier
54 first resonance coil
55 hybrid distributor
56 transmission/reception selection switch
57 power amplifier
58 ASK demodulator (DEM)
61 second resonance coil
62 coupling distributor
63 rectifier
64 ASK demodulator (DEM)
65 battery
66 reception/transmission selection switch
67 coupling distributor
68 limiter (LIM)
69 power amplifier
70 ASK modulator
71 carrier oscillator
72 ASK modulator
73 power amplifier
74 first resonance coil
75 antenna (feeding side reception section)
76 power amplifier
77 demodulator (DEM)
81 second resonance coil
82 coupling distributor
83 rectifier
84 ASK demodulator (DEM)
85 battery
86 oscillator
87 ASK modulator
87a FSK modulator
88 antenna (vehicle side reception section)
91 coupling distributor
92 limiter (LIM)
93 power amplifier
94 frequency divider
95 shift unit

1. A wireless charging system for a vehicle which transmits electric power outputted from a feeding apparatus to a vehicle side in a non-contact manner to thereby charge a battery mounted on the vehicle, wherein the feeding apparatus includes:
an electric power output section which outputs AC power;
a modulation section which superimposes a control signal on the AC power outputted from the electric power output section by using a predetermined modulation method;
an electric power amplifying section which amplifies the AC power modulated by the modulation section; and
a first communication terminal which transmits the AC power amplified by the electric power amplifying section, and
wherein the vehicle includes:
a second communication terminal which receives the AC power transmitted from the first communication terminal;
a demodulation section which demodulates the AC power received by the second communication terminal to thereby extract the control signal; and
a rectifying section which rectifies the AC power and supplies a DC power obtained by rectifying the AC power to the battery.

2. The wireless charging system for a vehicle according to claim 1, wherein the vehicle includes distributing section which distributes the AC power received by the second communication terminal into an AC power of a large power and an AC power of a small power,
the demodulation section extracts the control signal from the AC power of the small power, and the rectifying section rectifies the AC power of the large power.

3. The wireless charging system for a vehicle according to claim 2, wherein the DC power obtained by rectifying the AC power of the large power is used as electric power for driving the demodulation section.

4. The wireless charging system for a vehicle according to claim 1, wherein the first communication terminal has a transmission/reception function for transmitting the AC power and receiving the signal transmitted from the second communication terminal,
the second communication terminal has transmission/reception function for receiving the AC power and transmitting the signal to the first communication terminal,
the feeding apparatus includes a transmission/reception switch section for switching the first communication terminal in a transmission mode or a reception mode,
the vehicle includes a reception/transmission switch section for switching the second communication terminal in a reception mode or a transmission mode,
in a case of transmitting the AC power to the second communication terminal from the first communication terminal, the transmission/reception switch section is set to the transmission mode and the reception/transmission switch section is set to the reception mode,
in a case of transmitting the signal to the first communication terminal from the second communication terminal, the transmission/reception switch section is set to the reception mode and the reception/transmission switch section is set to the transmission mode, and the second communication terminal transmits the control signal by using an attenuated signal of the AC power as a carrier.

5. The wireless charging system for a vehicle according to claim 1, wherein the vehicle includes a vehicle side transmission section which transmits the control signal to the feeding apparatus,
the feeding apparatus includes a feeding side reception section which receives the control signal transmitted from the vehicle side,
the vehicle side transmission section includes an oscillation section which oscillates a carrier signal having a frequency different from a frequency of the AC signal, and the vehicle side transmission section superimposes the control signal on the carrier signal outputted from the oscillation section by using the predetermined modulation method and transmits the carrier signal to the feeding side reception section.

6. The wireless charging system for a vehicle according to claim 1, wherein the vehicle side transmission section includes carrier signal generation section which separates and extracts the carrier signal from the AC power received by the second communication terminal and changes a frequency of the carrier signal into another frequency, and the vehicle side transmission section superimposes the control signal on the carrier signal generated by the carrier signal generation section by using the predetermined modulation method and transmits the carrier signal to the feeding side reception section.

7. The wireless charging system for a vehicle according to claim 1, wherein the vehicle side transmission section separates and extracts the carrier signal from the AC power received by the second communication terminal and superimposes the control signal on the extracted carrier signal by using a frequency modulation method and transmits the carrier signal to the feeding side reception section.
